(19) United States
(12) Patent Application Publication
(10) Pub. No.: US 2026/0070177 A1
(43) Pub. Date: Mar. 12, 2026

(54) MACHINE TOOL SYSTEM

(71) Applicant: MURATA MACHINERY, LTD., Kyoto-shi, Kyoto (JP)

(72) Inventor: Ayako MASUDA, Inuyama-shi (JP)

(21) Appl. No.: 18/695,029

(22) PCT Filed: Aug. 19, 2022
(86) PCT No.: PCT/JP2022/031352

§ 371 Date: May 8, 2025

(30) Foreign Application Priority Data
Sep. 27, 2021 (JP) 2021-156755

(51) Int. Cl. B23Q 17/09; B23Q 3/155; B23Q 11/00

(52) U.S. Cl. CPC B23Q 17/0952; B23Q 3/155; B23Q 11/00

(57) ABSTRACT

[Problem] To easily discharge a workpiece remaining in a machining device or the like to an unloading platform when a use state of a tool has reached a predetermined value.

[Means to Solve Problem] A machine tool system 100 comprises: a processor 20 including a machining device 23 that machines a workpiece W with a tool T; a loading platform 10 on which the workpiece W to be processed in the processor 20 is placed; an unloading platform 30 on which the workpiece W processed in the processor 20 is placed; a loader device 40 that transports the workpiece W between the processor 20, the loading platform 10, and the unloading platform 30; and a controller 50 that controls the processor 20 and the loader device 30. When a use state of the tool T has reached a predetermined value, the controller 50 performs control so as to cause the loader device 40 to stop loading the workpiece W from the loading platform 10 to the processor 20, and cause the machining device 23 to perform machining on the workpiece W remaining in the processor 20 and then the loader device 40 to discharge the workpiece W to the unloading platform 30.

### TECHNICAL FIELD

The present invention relates to a machine tool system.

### Background Art

Machining devices, such as a lathe, include a tool that machines workpieces. The cutting edge of such a tool wears out as it continues to perform machining on workpieces, and, as a result, the tool needs to be replaced when the number of times machining is performed on workpieces or the total length of time for which machining has been performed on workpieces (use state) reaches a predetermined value (that is, when the end of the service life of the tool has been reached). For example, it has been proposed that even if the use state of a tool reaches the predetermined value mentioned above during a machining process being performed on a workpiece, the tool is still used to complete the machining process being performed on the workpiece, without stopping the machining device (See Patent Literature 1 below).

### CITATION LIST

### Patent Literature

[Patent Literature 1] Japanese published examined application, Publication No. H06-028838

### SUMMARY OF INVENTION

### Technical Problem

For loading and unloading workpieces into and from a machining device, a loader device is used. The loader device is used to transport unmachined workpieces on the loading platform to the machining device or to other devices that process the workpieces, and discharge the workpieces that have been machined or processed by those devices to the unloading platform. Thus, a loader device, a machining device, and other devices form a machine tool system. In such a machine tool system, if machining being performed on a workpiece is simply completed in the machining device during the machining process when the tool reaches the end of its service life as disclosed in Patent Literature 1, the workpiece will be left to remain in the machining device. Generally, when a tool has been replaced, trial machining needs to be performed on a workpiece, and it is also necessary that the workpiece that still remains in the machining device or other device be discharged to the unloading platform first. In such a case, the operator checks the remaining workpieces in the machining device or other device, and, depending on the number of remaining workpieces, manually performs an operation to extend the remaining service life of the tool by a predetermined amount, so that all the workpieces will be discharged to the unloading platform. However, such an operation takes a significant amount of time and effort of the operator.

An object of the present invention is to provide a machine tool system capable of easily discharging workpieces remaining in a machining device and the like to an unloading platform when the use state of a tool has reached a predetermined value.

### Means for Solving Problem

A machine tool system according to an aspect of the present invention comprises: a processor including a machining device that machines a workpiece with a tool; a loading platform on which the workpiece to be processed in the processor is placed; an unloading platform on which the workpiece processed in the processor is placed; a loader device that transports the workpiece between the processor, the loading platform, and the unloading platform; and a controller that controls the processor and the loader device. When a use state of the tool has reached a predetermined value, the controller performs control so as to cause the loader device to stop loading the workpiece from the loading platform to the processor, and cause the machining device to perform machining on the workpiece remaining in the processor and then the loader device to discharge the workpiece to the unloading platform.

### Advantageous Effects of the Invention

According to the machine tool system of the above aspect, when the use state of a tool has reached a predetermined value, the machining device continues to perform machining on the remaining workpiece in the processor without allowing new workpieces to be loaded thereinto, and the loader device further operates to discharge the machined workpieces to the unloading platform. As a result, the operator is not required to check the number of workpieces remaining in the processor and manually set the remaining service life of the tool, which can reduce the burden on the operator. When the use state of the tool has reached a predetermined value, workpieces remaining in the processor are discharged, and it is therefore possible to quickly perform trial machining on a workpiece after replacing the tool, and swiftly bring the machine tool system to the operable state.

In the machine tool system of the above aspect, the predetermined value may be set on the basis of a total number of times a workpiece has been machined by the tool or a total length of time for which workpieces have been machined by the tool, depending on the service life of the tool. According to such a configuration, workpieces remaining in the processor can be reliably discharged at the time of tool replacement. In the machine tool system of the above aspect, when the use state of the tool has reached a predetermined value, the controller may determine whether or not any workpiece remains in the processor by acquiring information regarding that the processor is processing a workpiece. According to such a configuration, it is possible to accurately determine whether or not any workpiece still remains in the processor at the time of tool replacement.

In the machine tool system of the above aspect, in addition to the machining device, the processor may include at least one of a pre-machining cleaning device that cleans a workpiece yet to be machined by the machining device, a phase determination device that determines the phase of a workpiece yet to be machined by the machining device, a post-machining cleaning device that cleans a workpiece that has been machined by the machining device, and a measuring device that measures dimensions of a workpiece that has been machined by the machining device. According to such a configuration, workpieces remaining in the processor including the machining device can also be reliably discharged to the unloading platform at the time of tool replacement. In the machine tool system of the above aspect, the controller may include a notifier that notifies that the use state of the tool has reached the predetermined value, and an inputter that causes the processor to process workpieces and the loader device to discharge workpieces. According to such a configuration, the operator confirms a notification from the notifier and then instructs via the inputter the processor to start processing and discharging the remaining workpieces. As a result, the time to start processing and discharging workpieces remaining in the processor can be set to any time desired by the operator.

In the machine tool system of the above aspect, the controller may cause the notifier to notify that all workpieces remaining in the processor have been discharged to the unloading platform. According to such a configuration, it is possible for the operator to easily perceive that all workpieces that remained in the processor have now been discharged to the unloading platform. In the machine tool system of the above aspect, the controller may cause the notifier to notify that the tool needs to be replaced. According to such a configuration, by checking the content of notification from the notifier, the operator can easily recognize that the tool needs to be replaced.

### BRIEF DESCRIPTION OF THE DRAWINGS

FIG. 1 is a front elevation view showing an example of a machine tool system according to an embodiment.

FIG. 2 is a plan view showing an example of the machine tool system according to the embodiment.

FIG. 3 is a diagram showing a state in which a loader device is gripping a workpiece on a loading platform.

FIG. 4 is a diagram showing a state in which the loader device has transferred the workpiece to a main spindle of a machining device.

FIG. 5 is a diagram showing a state in which the loader device has placed the workpiece on an unloading platform.

FIG. 6 is a flowchart showing an example of operations of the machine tool system.

FIG. 7 is a diagram showing a state in which workpieces are remaining in a processor.

FIG. 8 is a diagram showing a state in which the processor has executed processing on a workpiece and then the workpiece has been discharged to the unloading platform.

FIG. 9 is a flowchart showing another example of operations of the machine tool system.

### DESCRIPTION OF EMBODIMENTS

The following describes an embodiment of the present invention, with reference to the drawings. However, the present invention is not limited to the contents described below. In the drawings, scale is changed as necessary to illustrate the embodiment, such as by enlarging or emphasizing a portion, and the shapes and dimensions in the drawings may differ from those of the actual product. In the drawings, an XYZ coordinate system is used to describe directions in each drawing. In the XYZ coordinate system, a plane that is parallel to a horizontal plane is defined as an XY plane. A direction along this XY plane is denoted as X direction, and a direction orthogonal to the X direction is denoted as Y direction. A direction perpendicular to the XY plane is denoted as Z direction. For each of the X direction, the Y direction, and the Z direction, description is made with a definition in which a direction indicated by an arrow is the positive (+) direction and a direction opposite to the direction indicated by the arrow is the negative (−) direction.

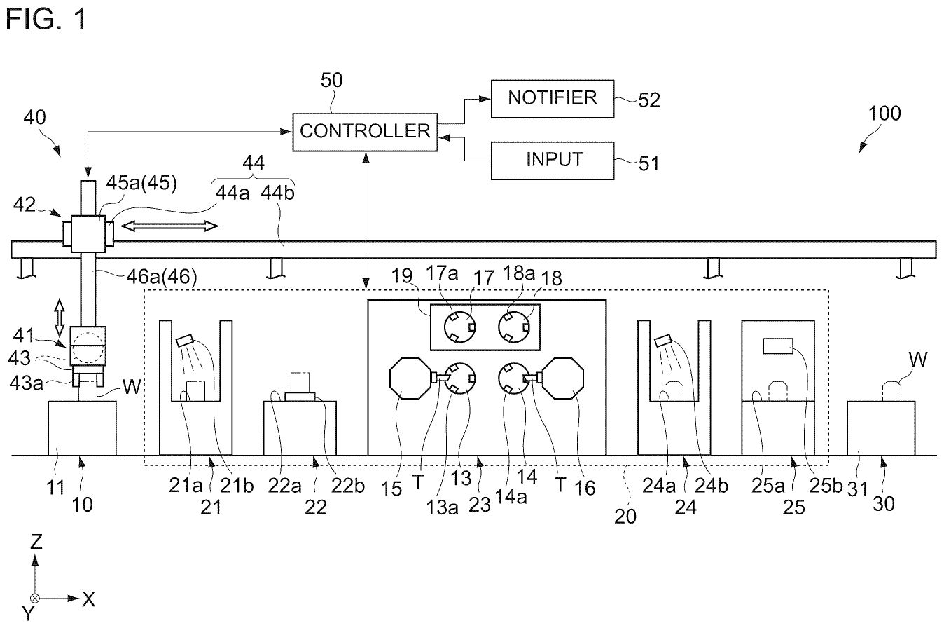

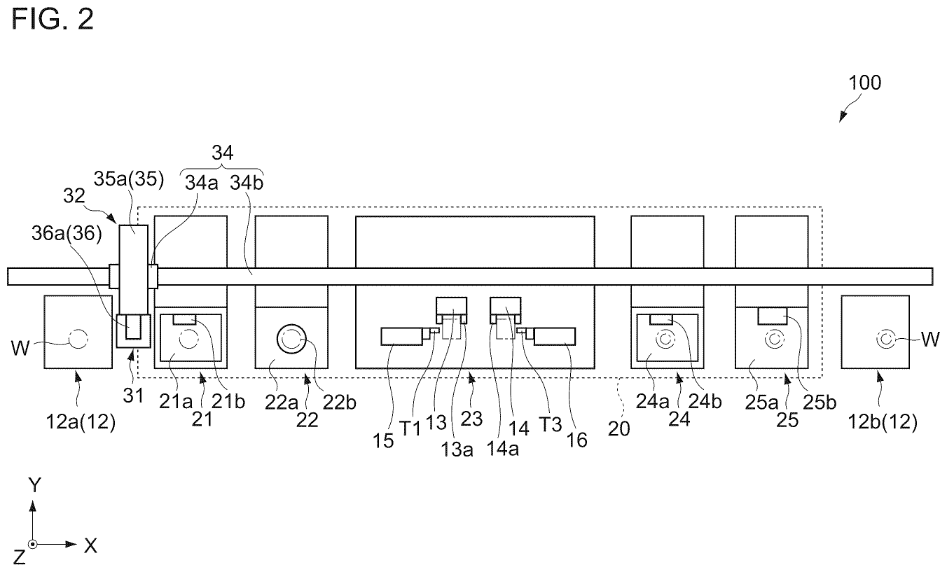

FIG. 1 is a front elevation view showing an example of a machine tool system 100 according to the present embodiment. FIG. 2 is a plan view showing an example of the machine tool system 100 according to the present embodiment. As shown in FIG. 1 and FIG. 2, the machine tool system 100 includes a loading platform 10, a processor 20, an unloading platform 30, a loader device 40, and a controller 50. A workpiece W to be processed by the processor 20 is placed on the loading platform 10. The loading platform 10 has a placement table 11 on which the workpiece W is held. The workpiece W, which has not been machined, is placed on the placement table 11.

The workpiece W is placed on the placement table 11 so that the loader device 40 can grip the workpiece W, which has not been machined. The loading platform 10 may, for example, of a configuration such that a plurality of unmachined workpieces W are held in a line along the rotational direction of a rotary member, and that the unmachined workpieces W are sequentially arranged at the gripping position of the loader device 40 as the rotary member rotates. The loading platform 10 may be of a form such that a conveyor extending in the Y direction is provided, and that the conveyor sequentially sends the unmachined workpieces W to the placement table 11 from the outside of the loading platform 10.

The processor 20 performs various processes on workpieces W. In the present embodiment, the processor 20 includes a pre-machining cleaning device 21, a phase determination device 22, a machining device 23, a post-machining cleaning device 24, and a measuring device 25.

The pre-machining cleaning device 21 cleans a workpiece W yet to be machined by the machining device 23. The pre-machining cleaning device 21 has a workpiece storage 21a and a cleaning fluid discharger 21b. An unmachined workpiece W is placed and stored in the workpiece storage 21a. The workpiece storage 21a is provided in a manner such that the upper part thereof is open to allow workpieces W to be transferred to and from the loader device 40 before and after cleaning.

The cleaning fluid discharger 21b cleans a workpiece W by discharging a cleaning fluid from the cleaning fluid discharger 21b toward the workpiece W stored in the workpiece storage 21a. However, the pre-machining cleaning device 21 is not limited to the example described above. The pre-machining cleaning device 21 may be of a configuration to perform ultrasonic cleaning on a workpiece W, or a configuration to spray a gas to a workpiece W to perform cleaning. It should be noted that whether or not to provide the pre-machining cleaning device 21 in the processor 20 is optional. That is to say, the pre-machining cleaning device 21 need not be provided in the processor 20.

The phase determination device 22 determines the phase of a workpiece W yet to be machined by the machining device 23. For example, in the case where a workpiece W has been machined previously, it may be necessary in some cases to align the phase (position) of the workpiece W during machining performed by the machining device 23 in order to align with the position that has previously been machined. In such a case, the phase determination device 22 determines the phase of the workpiece W by changing the position at the time when the loader device 40 grips the workpiece W.

The phase determination device 22 has a holding table 22a and a rotary table 22b. The holding table 22a has provided therein a driving mechanism not shown in the drawings that rotates the rotary table 22b. The rotary table 22b is rotatable around the Z axis with an unmachined workpiece W placed thereon. The rotary table 22b rotates the workpiece W around the Z axis, thereby determining the phase of the workpiece W. At this time, the phase determination device 22 may determine the phase of the workpiece W by detecting a part of the workpiece W using a sensor that can detect a part of a workpiece W, while rotating the workpiece W by the rotary table 22b. The workpiece W, the phase of which has now been determined by the rotary table 22b, is gripped by the loader device 40. The loader device 40 transports the workpiece W, the phase of which has been determined, to the machining device 23 for subsequent processing. It should be noted that whether or not to provide the phase determination device 22 in the processor 20 is optional. That is to say, the phase determination device 22 need not be provided in the processor 20.

The machining device 23 machines a workpiece W using a tool T. The machining device 23 is, for example, a lathe, and performs turning machining on a workpiece W. In the present embodiment, a parallel twin spindle lathe is used as the machining device 23. The machining device 23 has two main spindles 13, 14 and two turrets 15, 16. The main spindles 13, 14 each extend in the Y direction and are arranged in a line along the X direction. The main spindles 13, 14 are supported by bearings or the like not shown in the drawings so as to be able to rotate around axes parallel to the Y direction, and are both rotated by rotation drivers not shown in the drawings. Gripping claws 13a, 14a are provided at the −Y side ends of the main spindles 13, 14, respectively. A plurality of the gripping claws 13a, 14a are arranged at predetermined intervals along the rotational direction of the main spindles 13, 14. The gripping claws 13a, 14a can hold a workpiece W by moving in the radial direction of the main spindles 13, 14 by chuck drivers not shown in the drawings. By moving the gripping claws 13a, 14a, the workpiece W can be transferred to and from the loader device 40.

The turrets 15, 16 are arranged away from the axial direction of the main spindles 13, 14. The turret 15 is arranged on the +X side of the main spindle 13. The turret 16 is arranged on the-X side of the main spindle 14. The turrets 15, 16 can each be rotated around an axis parallel to the Y direction by a rotation driver not shown in the drawings. The turrets 15, 16 are both provided in a polygonal shape, for example. A plurality of holders for holding tools (cutting tools) T are provided on planar faces of the circumferential surfaces of the turrets 15, 16. All or some of these holders hold a tool T. By rotating the turrets 15, 16, a desired tool T for machining a workpiece W is selected. The tool T can be replaced in each holder. As the tool T, not only a tool bit that performs cutting on a workpiece W, but also a rotating tool such as a drill or an end mill may be used. The turrets 15, 16 can be moved in the X direction and the Y direction by drivers not shown in the drawings.

The machining device 23 includes a reversing device 19. The reversing device 19 reverses the direction of a workpiece W being transported from the main spindle 13 to the main spindle 14 in the Y direction, for example. The reversing device 19 includes chucks 17, 18 that can hold a workpiece W. The chucks 17, 18 are arranged in a line along the X direction, on the +Y side of (above) the main spindles 13, 14. Gripping claws 17a, 18a are provided at the −Y side ends of the chucks 17, 18, respectively. A workpiece W can be held by closing the gripping claws 17a, 18a.

The reversing device 19 includes a mover not shown in the drawings that moves one or both of the chucks 17, 18 from the state shown in the figure to a state in which they are facing each other. The mover causes the chucks 17, 18 to face each other, and return to the state shown in the figure after having transferred a workpiece W held by the chuck 17 to the chuck 18, whereby the direction of the workpiece W in the Y direction can be reversed. The loader device 40 can transfer a workpiece W to each of the chucks 17, 18. It should be noted that whether or not the machining device 23 includes the reversing device 19 is optional. That is to say, the machining device 23 need not include the reversing device 19.

The post-machining cleaning device 24 cleans the workpiece W that has been machined by the machining device 23. The post-machining cleaning device 24 has a workpiece storage 24a and a cleaning fluid discharger 24b. The machined workpiece W is placed and stored in the workpiece storage 24a. The workpiece storage 24a is provided in a manner such that the upper part thereof is open to allow workpieces W to be transferred to and from the loader device 40 before and after cleaning. The cleaning fluid discharger 24b removes cutting chips, machining lubricant, and so forth attached to the workpiece W by discharging a cleaning fluid from the cleaning fluid discharger 24b toward the workpiece W stored in the workpiece storage 24a. It should be noted that the post-machining cleaning device 24 is not limited to the example described above. the post-machining cleaning device 24 may be of a configuration to perform ultrasonic cleaning on a workpiece W to remove cutting chips and so forth, or a configuration to spray a gas to a workpiece W to remove cutting chips and so forth. It should be noted that whether or not to provide the post-machining cleaning device 24 in the processor 20 is optional. That is to say, the post-machining cleaning device 24 need not be provided in the processor 20.

The measuring device 25 measures a workpiece W that has been cleaned by the post-machining cleaning device 24. The measuring device 25 has a placement table 25a and a sensor 25b. A measurement-target workpiece W that has been machined is placed on the placement table 25a. The placement table 25a is configured so as to be able to transfer a workpiece W to and from the loader device 40. The sensor 25b measures dimensions and the like of a workpiece W placed on the placement table 25a. The measuring device 25 measures the three-dimensional shape of a workpiece W, for example, by emitting detection light to the workpiece W from the sensor 25b and acquiring the reflected light. It should be noted that whether or not to provide the measuring device 25 in the processor 20 is optional. That is to say, the measuring device 25 need not be provided in the processor 20.

A workpiece W that has been processed in the processor 20 is placed on the unloading platform 30. On the unloading platform 30, a machined workpiece W the dimensions of which have been measured by the measuring device 25 is placed. The unloading platform 30 has a placement table 31 on which a workpiece W is placed. The placement table 31 is configured so as to be able to receive a machined workpiece W that has been transported by the loader device 40. For example, the unloading platform 30 may be of a form such that a conveyor extending in the Y direction is provided, and that the conveyor sends the workpiece W placed on the placement table 31 to the outside of the placement table 31.

The loader device 40 transports workpieces W between the loading platform 10, the processor 20, and the unloading platform 30. After having transported a workpiece W from the loading platform 10 to the pre-machining cleaning device 21 of the processor 20, the loader device 40 transports, in the processor 20, the workpiece W from the pre-machining cleaning device 21 to the phase determination device 22. Next, after having transported the workpiece W from the phase determination device 22 to the main spindle 13 of the machining device 23, the loader device 40 transports the workpiece W from the main spindle 13 to the chuck 17 of the reversing device 19 and transports the workpiece W from the chuck 18 to the main spindle 14. Next, after having transported the workpiece W from the main spindle 14 to the post-machining cleaning device 24 and having transported the workpiece W from the post-machining cleaning device 24 to the measuring device 25, the loader device 40 transports the workpiece W from the measuring device 25 to the unloading platform 30.

The loader device 40 includes a loader head 41 and a loader driver 42. The loader head 41 has a loader chuck 43. The loader chuck 43 can grip a workpiece W by opening and closing a plurality of gripping claws 43a. The loader head 41 is formed so as to be able to change the attitude of the loader chuck 43, for example, between an attitude in which it faces in the-Z direction while holding a workpiece W and an attitude in which it faces in the +Y direction (attitude in which the workpiece W faces the main spindles 13, 14), by means of a so-called swivel joint as an example. It should be noted that the loader head 41 is not limited to having a swivel joint, and any other form can be used.

The loader driver 42 includes an X-direction driver 44, a Y-direction driver 45, and a Z-direction driver 46.

The X-direction driver 44 has an X-direction moving body 44a and a guide rail 44b. The X-direction moving body 44a is provided so as to be able to move in the X direction along the guide rail 44b by means of a drive source not shown in the drawings. The Y-direction driver 45 is formed on the X-direction moving body 44a. The Y-direction driver 45 has a Y-direction moving body 45a. The Y-direction moving body 45a is provided so as to be able to move in the Y direction along a guide not shown in the drawings by means of a drive source not shown in the drawings. The Z-direction driver 46 is formed on the Y-direction moving body 45a. The Z-direction driver 46 has a Z-direction moving body 46a. The Z-direction moving body 46a is provided so as to be able to move in the Z direction along a guide not shown in the drawings by means of a drive source not shown in the drawings.

The loader head 41 is provided at the lower part of the Z-direction moving body 46a. With driving of each of the X-direction driver 44, the Y-direction driver 45, and the Z-direction driver 46, the workpiece W gripped by the loader chuck 43 of the loader head 41 is transported in the X direction, Z direction, Y direction, or a combination of these directions.

The controller 50 comprehensively controls the operations of the processor 20 and the loader device 40 on the basis of a predetermined machining program. A plurality of controllers 50 that individually control the processor 20 and the loader device 40 may be provided. The controller 50 has provided therein a communicator not shown in the drawings. This communicator is configured to communicate various information such as the processing status of workpieces W in the processor 20 and the operating status of the loader device 40. On the basis of information acquired through the communicator, the controller 50 can recognize that a workpiece W remains in the processor 20 and that the loader device 40 is transporting the workpiece W.

The controller 50 determines whether or not the use state of the tool T used in the machining device 23 has reached a predetermined value. The predetermined value is preliminarily set depending on the service life of the tool T, and is set, for example, on the basis of the total number of times workpieces W have been machined by the tool T or the total length of time for which workpieces W have been machined by the tool. The predetermined value may be, for example, a value acquired from a host controller, or a value input by the operator using an inputter 51, which will be described later. When the use state of the tool T has reached the predetermined value, the controller 50 acquires information regarding that the processor 20 is processing workpieces. This information includes, for example, information regarding that a workpiece W remains and information that the workpiece W is being processed.

When the use state of the tool T has reached the predetermined value, the controller 50 may cause a notifier 52, which will be described later, to notify that the use state of the tool T has reached the predetermined value.

The controller 50 determines whether or not any workpiece W remains in the processor 20 on the basis of the information acquired from the processor 20. If it is determined that there is no workpiece W remaining in the processor 20, the controller 50 may cause the notifier 52 to notify that all remaining workpieces W in the processor 20 have been discharged to the unloading platform 30 and that the tool T needs to be replaced, for example. If it is determined that the use state of the tool T has reached the predetermined value, the controller 50 causes the loader device 40 to stop loading workpieces W from the loading platform 10 to the processor 20, and perform a discharging process for workpieces W. In the present embodiment, the discharging process is a process of causing the loader device 40 to discharge (transport) workpieces W to the unloading platform 30 after causing the machining device 23 to perform machining on the workpiece W remaining in the processor 20. After this discharging process has been executed, all remaining workpieces W in the processor 20 have been discharged to the unloading platform 30, and the processor 20 is in the empty state with no workpiece W present therein. As a result of the processor 20 becoming empty, it is possible to smoothly resume the operation of the machine tool system 100 after replacing the tool T.

The controller 50 includes the inputter 51 and the notifier 52. As the inputter 51, for example, an operation panel, a touch panel, a keyboard, a mouse, a trackball, or the like is used. The inputter 51 allows input of information for executing the discharging process for workpieces W when the use state of the tool T has reached the predetermined value. The inputter 51 detects an input from the operator and transmits the input information to the controller 50. The inputter 51 may also be used as an operation panel of the machine tool system 100. Through the operation panel, the operator can input machining conditions such as the program for the machining device 23 to machine workpieces W, the material of workpieces W, and the type of tool T to be used, for example. The machining conditions may be sent from the host controller, and the operator may modify or correct the machining conditions using the operation panel.

The notifier 52 notifies various information under control of the controller 50. The notifier 52 is, for example, a display device such as a display or a touch panel, an audio output device such as a speaker or an alarm, a computer, or a mobile terminal such as a smartphone. As described above, the notifier 52 notifies that the use state of the tool T has reached the predetermined value. The notifier 52 also notifies that all remaining workpieces W in the processor 20 have been discharged to the unloading platform 30. The notifier 52 can also notify that the tool T needs to be replaced. Notifications of the notifier 52 allow the operator to recognize that the use state of the tool T has reached the predetermined value, that there are workpieces W remaining in the processor 20, that all remaining workpieces W in the processor 20 have been discharged to the unloading platform 30, and that the tool T needs to be replaced.

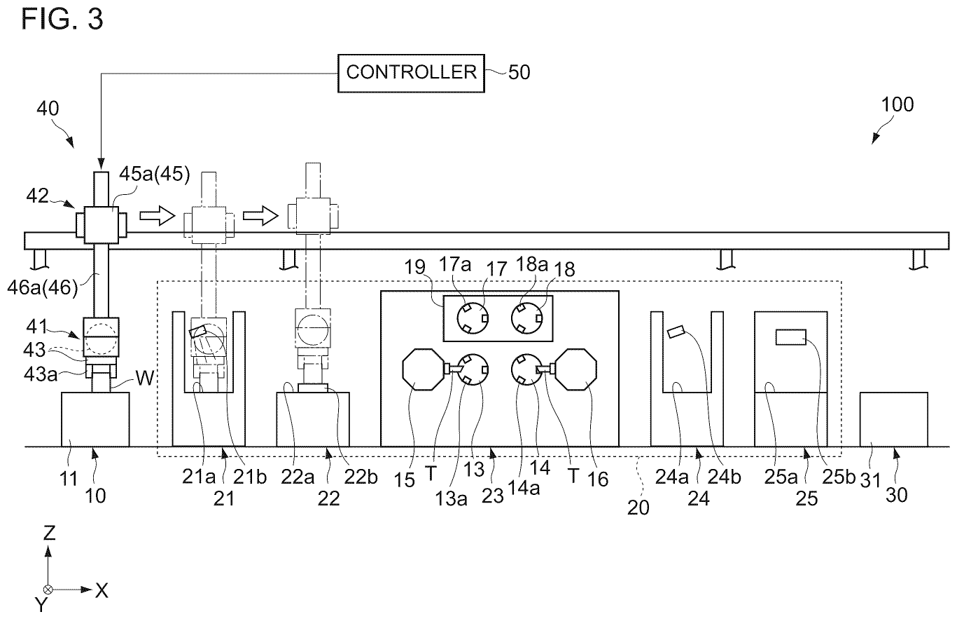

Next, the operation of the machine tool system 100 configured as described above will be described. FIG. 3 to FIG. 5 are diagrams showing an example of the operations of the machine tool system 100. FIG. 3 is a diagram showing a state in which the loader device 40 is gripping a workpiece W on the loading platform 10. The operations of machine tool system 100 are performed under control of the controller 50. First, the loader device 40 arranges the loader head 41 above the placement table 11 of the loading platform 10 (on the +Z side), and lowers the Z-direction moving body 46a with the loader chuck 43 facing downward.

Next, the workpiece W, which has preliminarily been arranged on the loading platform 10, is held by the gripping claws 43a of the loader head 41. Then, the Z-direction driver 46 raises the loader head 41.

Then, the loader head 41 moves in the +X direction to arrange the workpiece W above the pre-machining cleaning device 21. Then, the Z-direction moving body 46a descends to store the workpiece W in the workpiece storage 21a of the pre-machining cleaning device 21. After having placed the workpiece W in the workpiece storage 21a, the loader head 41 ascends. The pre-machining cleaning device 21 discharges the cleaning fluid from the cleaning fluid discharger 21b to clean the workpiece W in the workpiece storage 21a. After having cleaned the workpiece W, the loader head 41 descends to hold the workpiece W that has been cleaned. The loader head 41 holding the workpiece W ascends, and then moves in the +X direction to arrange the workpiece W above the phase determination device 22.

Then, the loader head 41 descends to place the workpiece W on the rotary table 22b of the phase determination device 22. After having placed the workpiece W on the rotary table 22b, the loader head 41 ascends. The phase determination device 22 rotates the rotary table 22b and determines the phase of the workpiece W. After having determined the phase of the workpiece W, the loader head 41 descends, and ascends after the workpiece W has been held. The loader head 41 then moves in the +X direction to arrange the workpiece W above the main spindle 13. Then, the loader head 41 descends to arrange the workpiece W on the −Y side of the main spindle 13. Then, the loader head 41 turns the orientation of the workpiece W from the downward orientation to the +Y direction orientation. Then, the loader head 41 moves in the +Y direction, so that the workpiece W will be gripped by the gripping claws 13a of the main spindle 13 and transferred from the loader head 41 to the main spindle 13.

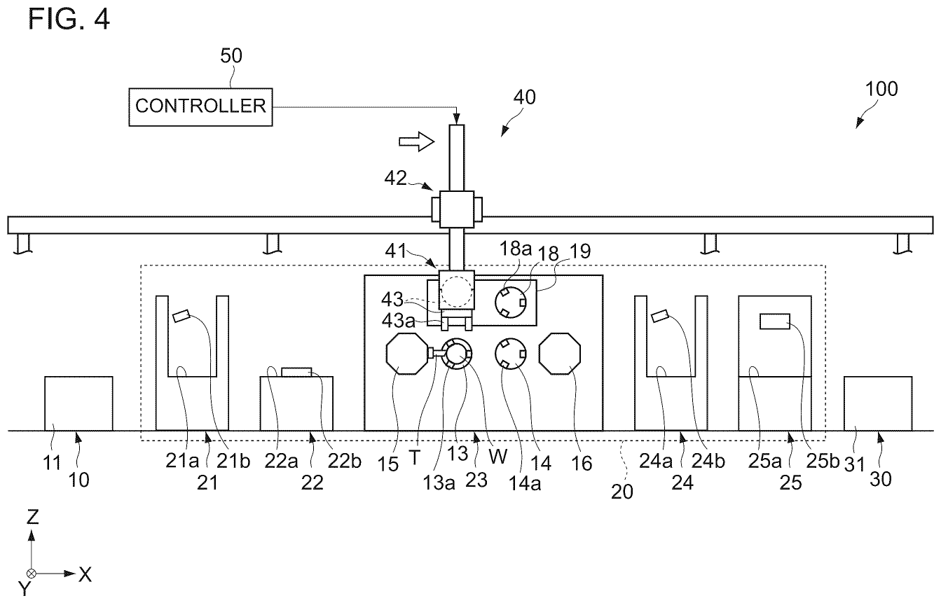

FIG. 4 is a diagram showing a state in which the loader device 40 has transferred the workpiece W to the main spindle 13. After the workpiece W has been held on the main spindle 13, the loader head 41 moves in the −Y direction, then ascends, and returns above the main spindle 13. In the machining device 23, the turret 15 rotates and a tools T for machining the workpiece W is selected. The machining device 23 performs turning machining on the workpiece W by rotating the main spindle 13 to rotate the workpiece W around the axis parallel to the Y direction and moving the tool T (turret 15) in the X direction and the Y direction. While the machining device 23 performs machining on the workpiece W, the loader device 40 may transport a new unmachined workpiece W from the loading platform 10 to the pre-machining cleaning device 21.

After the workpiece W has been machined in the machining device 23, the loader head 41 receives the workpiece W from the main spindle 13, and then transfers the workpiece W to the chuck 17 of the reversing device 19. The reversing device 19 transfers the workpiece W held by the chuck 17 to the chuck 18 to reverse the workpiece W.

After having received the workpiece W from the chuck 18, the loader head 41 transfers the workpiece W to the main spindle 14 of the machining device 23. In the machining device 23, the turret 16 rotates and a tools T for machining the workpiece W is selected. The machining device 23 performs turning machining on the workpiece W by rotating the main spindle 14 to rotate the workpiece W around the axis parallel to the Y direction and moving the tool T (turret 16) in the X direction and the Y direction.

Next, after having received the workpiece W from the main spindle 14, the loader head 41 ascends and then moves in the +X direction to arrange the workpiece W above the post-machining cleaning device 24. Then, the loader head 41 descends to store the machined workpiece W in the workpiece storage 24a of the post-machining cleaning device 24. After having stored the workpiece W in the workpiece storage 24a, the loader head 41 ascends. The post-machining cleaning device 24 discharges the cleaning fluid from the cleaning fluid discharger 21b toward the workpiece W to clean the machined workpiece W. After having cleaned the workpiece W, the loader head 41 descends to hold the workpiece W that has been cleaned. Next, the loader head 41 ascends, and then moves in the +X direction to arrange the workpiece W above the measuring device 25. Then, the loader head 41 descends to place the workpiece W on the placement table 25a of the measuring device 25. After having placed the workpiece W on the placement table 25a, the loader head 41 ascends. The measuring device 25 uses the sensor 25b to measure the workpiece W placed on the placement table 25a.

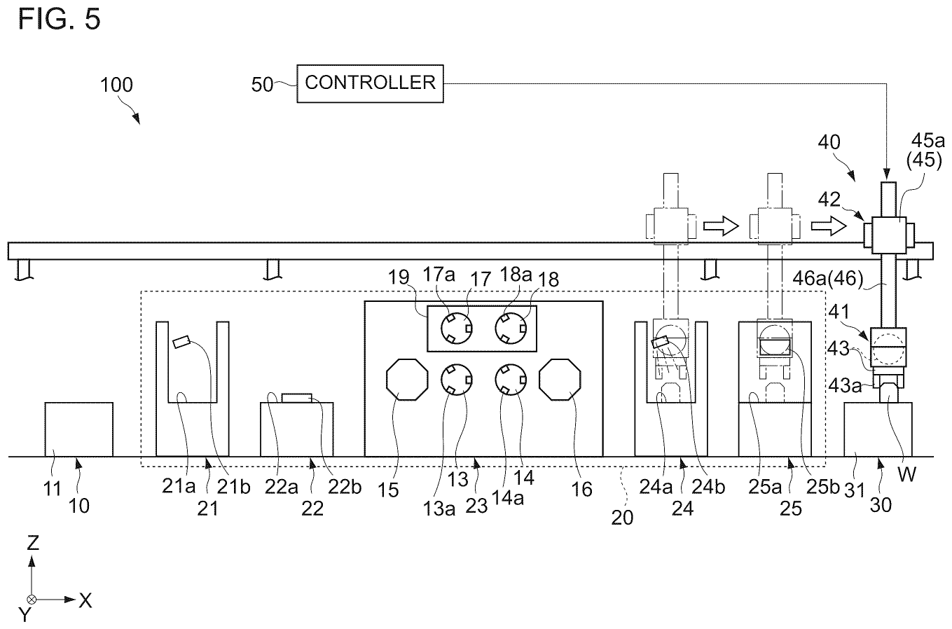

FIG. 5 is a diagram showing a state in which the loader device 40 has placed the workpiece W on the unloading platform 30. After the measuring device 25 has measured the workpiece W, the loader head 41 descends to hold the workpiece W that has been measured. Next, the loader head 41 ascends, and then moves in the +X direction to arrange the workpiece W above the unloading platform 30. The loader head 41 then descends to thereby place the measured workpiece W on the placement table 31 of the unloading platform 30, as shown in FIG. 5. Through this series of operations, the workpiece W in the loading platform 10 is transported into the processor 20, processed by the processor 20, and then transferred to the unloading platform 30.

Through the series of operations described above, the loader device 40 transports a plurality of workpieces W from the loading platform 10 to the processor 20, and the workpieces W are sequentially sent to the processor 20. Then, the workpieces W are discharged to the unloading platform 30. That is to say, in the processor 20, a plurality of workpieces W are processed by one of the devices, and the loader device 40 transports the workpieces W as appropriate. While these operations are taking place, the cutting edge of the tool T used by the machining device 23 wears out as it continues to perform machining on workpieces W, and, as a result, the tool T needs to be replaced when the number of times machining has been performed on workpieces W or the total length of time for which machining has been performed on workpieces W (use state) reaches a predetermined value (that is, when the end of the service life of the tool has been reached). The predetermined value serving as an indication for replacing the tool T is set, for example, as a value of the number of times workpieces W can be machined. However, the predetermined value is set with an extra margin in order to still allow machining to be performed on a workpiece W multiple times even when the tool T has reached the predetermined value. When the tool T has reached the predetermined value, changing this predetermined value will extend the service life of the tool T. The predetermined value is changed by adding to the preset predetermined value a value sufficient to perform machining on the remaining workpieces in the processor 20. The preliminarily set predetermined value is stored, a notification is made regarding the tool reaching the end of its service life, and the tool is replaced by the operator after the workpieces W have been discharged.

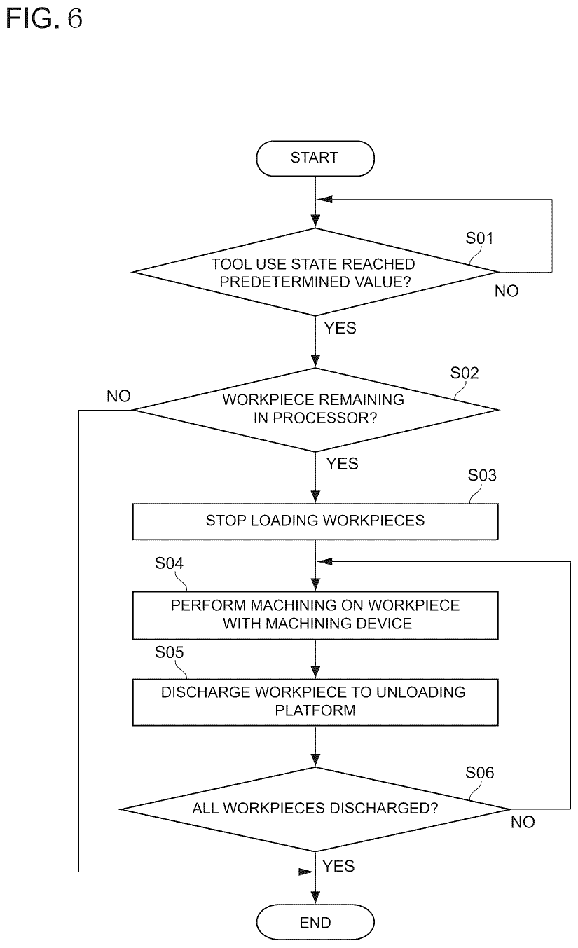

FIG. 6 is a flowchart showing an example of the operations of the machine tool system 100. As shown in FIG. 6, the controller 50 determines whether or not the use state of the tool T used in the machining device 23 has reached the predetermined value (Step S01). On the basis of the information sent from the machining device 23, the controller 50 compares the number of machining times or the total machining time of the tool T with the predetermined value of the tool T, and determines whether or not the use state of the tool T has reached the predetermined value. If it is determined that the use state of the tool T has not reached the predetermined value (Step S01: NO), the controller 50 repeats the processing of Step S01.

Next, if it is determined that the use state of the tool T has reached the predetermined value (Step S01: YES), the controller 50 determines whether or not any workpiece W remains in the the processor 20 (Step S02). The controller 50 acquires information regarding processing of a workpiece W from each device of the processor 20 (for example, the machining device 23 or the like), and determines whether or not any workpiece W remains in the processor 20, on the basis of the acquired information (Step S02). Where appropriate, the controller 50 acquires from each device of the processor 20 information regarding that a workpiece W is being processed or that the processing of a workpiece W has been completed, for example. On the basis of this information, the controller 50 determines whether or not any workpiece W remains in the processor 20. In such a case, even if a workpiece W is being transported by the loader device 40 on the basis of the information acquired from the loader device 40, the controller 50 determines that as a workpiece W remaining in the processor 20.

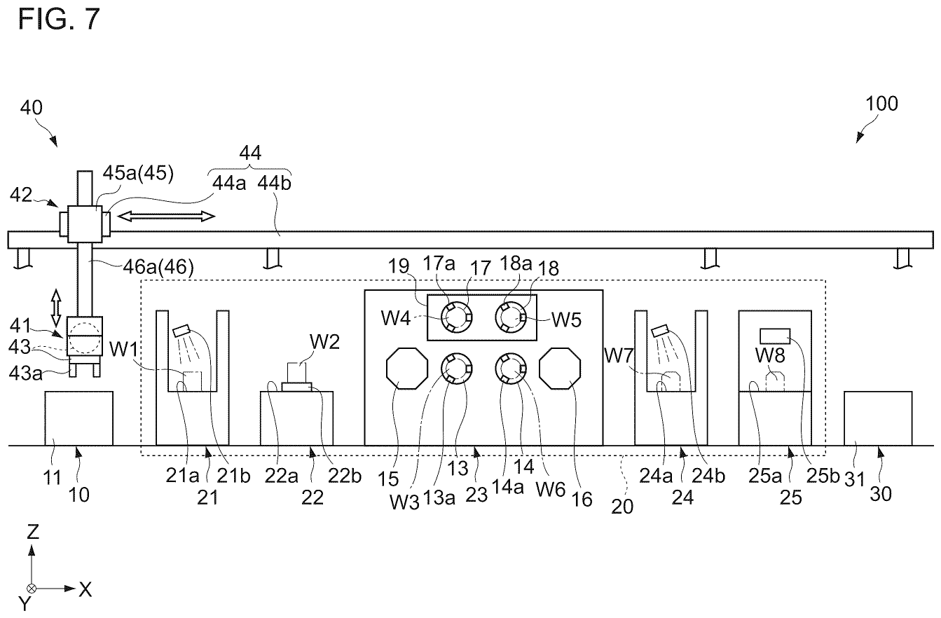

FIG. 7 is a diagram showing a state in which workpieces W are remaining in the processor 20. As shown in FIG. 7, when the use state of the tool T has reached the predetermined value, in the processor 20, there is a possibility of a workpiece W remaining in at least one of the pre-machining cleaning device 21 (workpiece W1), the phase determination device 22 (workpiece W2), the main spindle 13 of the machining device 23 (workpiece W3), the chuck 17 (workpiece W4), the chuck 18 (workpiece W5), the main spindle 14 (workpiece W6), the post-machining cleaning device 24 (workpiece W7), and the measuring device 25 (workpiece W8). Although not shown in the drawings, there is a possibility that a workpiece W being transported by the loader device 40 may also be remaining. The controller 50 acquires information from each device of the processor 20 regarding that the processor 20 is processing the workpieces W1 to W8, that it is holding the workpieces before processing, or that it is holding the workpieces after processing, and acquires information regarding that there is a workpiece W being transported by the loader device 40. In Step S02, on the basis of the acquired information, the controller 50 determines whether or not any workpiece W remains.

Next, as shown in FIG. 6, if it is determined that a workpiece W remains in the processor 20 (Step S02: YES), the controller 50 causes the loader device 40 to stop loading workpieces W from the loading platform 10 to the processor 20 (Step S03). If it is determined that no workpiece W remains in the processor 20 (Step S02: NO), the controller 50 ends the series of processes. In Step S03, the controller 50 causes the loader device 40 to stop loading workpieces W, so that no new unmachined workpiece W will be loaded into the processor 20 from the loading platform 10.

Next, the controller 50 performs the discharging process for the workpieces W. If it is determined in Step S02 that there is any workpiece W remaining in the processor 20, the controller 50 determines the number of remaining workpieces W in the processor 20, and acquires information regarding in which device and in what state each of the remaining workpieces W is. The controller 50 causes the machining device 23 to execute machining on the workpieces W remaining in the processor 20 (Step S04). Step S04 may be executed automatically by the controller 50 on the basis of a preliminarily set instruction content, or may be executed according to an instruction manually input by the operator. Execution of this discharging process results in extending the service life of the tool T, so that the machining device 23 does not stop performing machining on the workpiece W and the subsequent steps can be executed. The extent to which the service life of the tool T is to be extended may be represented as a preset value, or may be a value manually set by the operator.

The controller 50 acquires the state of each remaining workpiece W, and causes the processor 20 to continue to execute the process on the basis of the current state. For example, the workpiece W1 shown in FIG. 7 continues to be processed by the pre-machining cleaning device 21, and after having been cleaned, the workpiece W1 is sent to the phase determination device 22 on the subsequent stage, and the subsequent processing is executed. Similarly, after having been phase-determined by the phase determination device 22, the workpiece W2 is sent to the main spindle 13 of the machining device 23 on the subsequent stage, and the subsequent processing is executed. After having been machined by the tool T, the workpiece W3 is sent from the main spindle 13 to the chuck 17 of the reversing device 19, and the subsequent processing is executed. The workpiece W4 is transferred from the chuck 17 to the chuck 18, and the subsequent processing is executed. The workpiece W5 is sent from the chuck 18 to the chuck 14, and the subsequent processing is executed. After having been machined by the tool T, the workpiece W6 is sent from the main spindle 14 to the post-machining cleaning device 24 on the subsequent stage, and the subsequent processing is executed. After having been cleaned by the post-machining cleaning device 24, the workpiece W7 is sent to the measuring device 25 on the subsequent stage, and the subsequent processing is executed. After having been measured by the measuring device 25, the workpiece W8 is discharged from the processor 20 to the unloading platform 30.

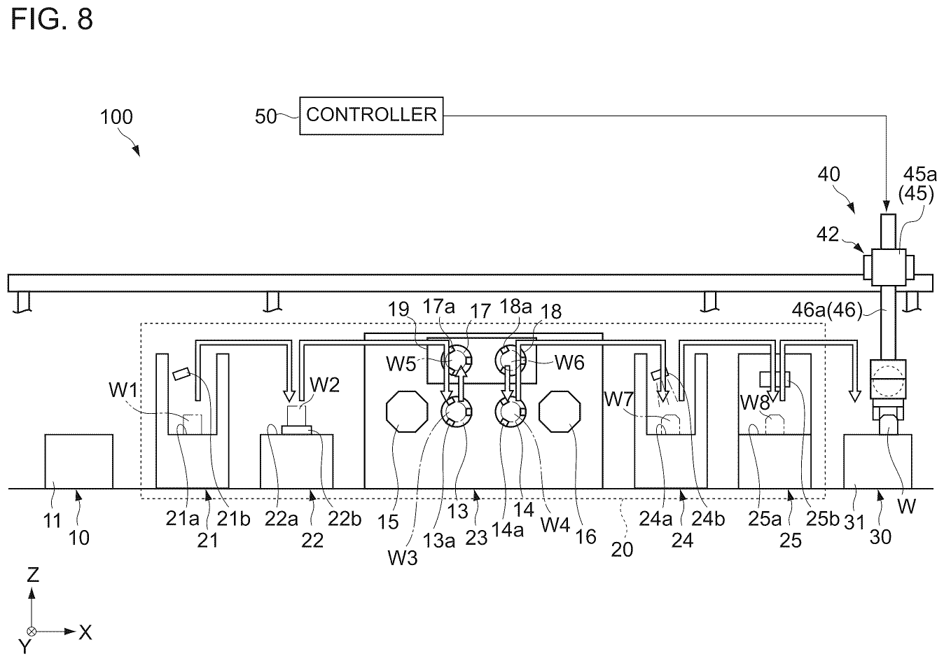

FIG. 8 is a diagram showing a state in which the processor 20 has executed processing on a workpiece W and then the workpiece W has been discharged to the unloading platform 30. In Step S04 described above, after having continued to perform processing on workpieces W remaining in the processor 20, the controller 50 causes the loader device 40 to discharge the workpieces W to the unloading platform 30 (Step S05). After the series of processes including machining performed by the machining device 23 have been completed in the processor 20, the remaining workpieces W in the processor 20 are discharged to the unloading platform 30 by the loader device 40. As shown in FIG. 8, the processing continues to be performed on the workpieces W1, W2, W3, W4, W5, W6, W7, and W8 in the processor 20, and after having been measured by the measuring device 25, the workpieces W1, W2, W3, W4, W5, W6, W7, and W8 are discharged to the unloading platform 30 by the loader device 40. As described above, the predetermined value regarding the use state of the tool T is set with an extra margin to perform machining on multiple workpieces W, and therefore, even when the use state of the tool T reaches the predetermined value, machining with the tool T can still be performed on the workpieces W remaining in the processor 20.

Next, as shown in FIG. 6, the controller 50 determines whether or not all the workpieces W have been discharged to the unloading platform 30 (Step S06). The controller 50 determines whether or not all the remaining workpieces W in the processor 20 have been discharged to the unloading platform 30. If it is determined that all the remaining workpieces W in the processor 20 have been discharged to the unloading platform 30 (Step S06: YES), the controller 50 ends the series of processes. If it is determined that all the remaining workpieces W in the processor 20 have not been discharged to the unloading platform 30 (Step S06: NO), the controller 50 repeats the processing of Step S04 and the subsequent processing.

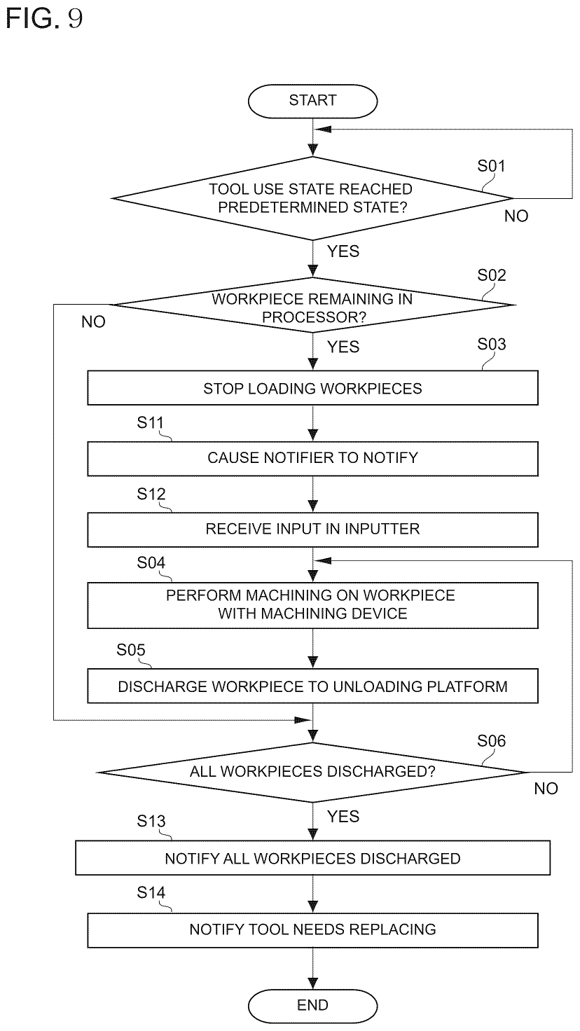

FIG. 9 is a flowchart showing another example of the operations of the machine tool system 100. In the example shown in FIG. 9, the processing from Step S01 to Step S06 is the same as that described above, and therefore, the description thereof will be omitted. After Step S03, the controller 50 causes the notifier 52 (see FIG. 1) to notify that the use state of the tool T has reached the predetermined value (Step S11). In response to the instruction from the controller 50, by means of a screen display or sound from a speaker, the notifier 52 notifies the operator of that the tool T in use has reached the predetermined value.

Next, based on the notification of the notifier 52, the operator recognizes that the tool T needs to be replaced. The operator inputs an instruction to the inputter 51 (see FIG. 1) to cause the processor 20 to process workpieces W and the loader device 40 to discharge the workpieces W (Step S12). Thus, the discharging process is performed for the workpieces W remaining in the processor 20 on the basis of the instruction input from the operator, whereby the discharging of the workpieces W can be executed at the timing desired by the operator. Next, upon accepting the instruction input through the inputter 51 from the operator, as described above, the controller 50 causes the machining device 23 to perform machining on the remaining workpieces W in the processor 20 (Step S04) and the loader device 40 to discharge the workpieces W to the unloading platform 30 (Step S05), until all the remaining workpieces W in the processor 20 have been discharged (Step S06).

In Step S06, if it is determined that all the workpieces W have been discharged to the unloading platform 30 (Step S06: YES), the controller 50 causes the notifier 52 to notify that all the remaining workpieces W in the processor 20 have been discharged to the unloading platform 30 (Step S13). In response to the instruction from the controller 50, by means of a screen display or sound from a speaker, the notifier 52 notifies the operator of that all the workpieces W have been discharged to the unloading platform 30. Next, the controller 50 causes the notifier 52 to notify that the tool T needs to be replaced (Step S14). In response to the instruction from the controller 50, by means of a screen display or sound from a speaker, the notifier 52 notifies the operator of that the tool T needs to be replaced. Having recognized this notification, the operator can now begin to perform the task of replacing the tool T. The series of processes ends when Step S14 is completed.

As described above, according to the machine tool system 100 of the present embodiment, when the use state of the tool T has reached a predetermined value, the machining device 23 continues to perform machining on remaining workpieces W in the processor 20 without allowing new workpieces W to be loaded thereinto, and the loader device 40 further operates to discharge the machined workpieces W to the unloading platform 30. Therefore, there is no need for the operator to manually set the remaining service life of the tool T, which can reduce the burden on the operator. Furthermore, when the use state of the tool T has reached the predetermined value, workpieces W remaining in the processor 20 are discharged, and therefore, it is possible to quickly perform trial machining on a workpiece W after changing the tool T, and swiftly bring the machine tool system 100 to the operable state.

The embodiment of the present invention has been described above. However, the technical scope of the invention is not limited to the description of the above embodiment. It is also apparent to those skilled in the art that various modifications or improvements can be added to the above embodiment. The technical scope of the present invention also encompasses one or more of such modifications or improvements. One or more of the requirements described in the above embodiment may be omitted in some cases. One or more of the requirements described in the above embodiment may be combined where appropriate. The order of executing processes shown in the present embodiment can be realized in an arbitrary order unless the result of the previous processing is used in the following processing. While operations in the above embodiment have been described with expressions such as “first”, “next”, and “subsequently” for the sake of convenience, the operations need not always be implemented in that order. The contents of Japanese Patent Application No. 2021-156755 and all documents cited in the detailed description of the present invention are incorporated herein by reference to the extent permitted by law.

In the embodiment described above, an example has been described in which one loader device 40 having one loader head 41 is used, however, the invention is not limited to this example. For example, two or more loader devices 40 may operate independently. Also, one loader device 40 may include a plurality of loader heads 41.

### DESCRIPTION OF REFERENCE SIGNS

T: Tool
W, W1, W2, W3, W4, W5, W6, W7, W8: Workpiece
10: Loading platform
13, 14: Main spindle
15, 16: Turret
19: Reversing device
20: Processor
21: Pre-machining cleaning device
22: Phase determination device
23: Machining device
24: Post-machining cleaning device
25: Measuring device
30: Unloading platform
40: Loader device
50: Controller
51: Inputter
52: Notifier
100: Machine tool system

1. A machine tool system comprising:
a processor including a machining device that machines a workpiece with a tool;
a loading platform on which the workpiece to be processed in the processor is placed;
an unloading platform on which the workpiece processed in the processor is placed;
a loader device that transports the workpiece between the processor, the loading platform, and the unloading platform; and
a controller that controls the processor and the loader device,
wherein when a use state of the tool has reached a predetermined value, the controller performs control so as to cause the loader device to stop loading the workpiece from the loading platform to the processor, and cause the machining device to perform machining on the workpiece remaining in the processor and then the loader device to discharge the workpiece to the unloading platform.

2. The machine tool system according to claim 1,
wherein the predetermined value is set on the basis of a total number of times the workpiece is machined by the tool or a total length of time for which the workpiece is machined by the tool, depending on a service life of the tool.

3. The machine tool system according to claim 1 or 2,
wherein when the use state of the tool has reached a predetermined value, the controller determines whether or not the workpiece remains in the processor by acquiring information regarding that the processor is processing the workpiece.

4. The machine tool system according to any one of claims 1 to 3,
wherein in addition to the machining device, the processor includes at least one of a pre-machining cleaning device that cleans the workpiece yet to be machined by the machining device, a phase determination device that determines the phase of the workpiece yet to be machined by the machining device, a post-machining cleaning device that cleans the workpiece that has been machined by the machining device, and a measuring device that measures dimensions of the workpiece that has been machined by the machining device.

5. The machine tool system according to any one of claims 1 to 4,
wherein the controller includes a notifier that notifies that the use state of the tool has reached the predetermined value, and an inputter that causes the processor to process the workpiece and the loader device to discharge the workpiece.

6. The machine tool system according to claim 5,
wherein the controller causes the notifier to notify that all the workpieces remaining in the processor have been discharged to the unloading platform.

7. The machine tool system according to claim 5 or 6,
wherein the controller causes the notifier to notify that the tool needs to be replaced.
